(19) United States
(12) Patent Application Publication
(10) Pub. No.: US 2021/0030131 A1
(43) Pub. Date: Feb. 4, 2021

(54) A RAZOR CARTRIDGE CLEANING DEVICE

(71) Applicant: Michael KILBY, Bairnsdale (AU)

(72) Inventor: Michael KILBY, Bairnsdale (AU)

(21) Appl. No.: 16/971,426

(22) PCT Filed: Feb. 20, 2019
(86) PCT No.: PCT/AU2019/050136

§ 371 Date: Aug. 20, 2020

(30) Foreign Application Priority Data
Feb. 21, 2018 (AU) 2018900541

(51) Int. Cl. A45D 27/46; B08B 3/02

(52) U.S. Cl. CPC A45D 27/46; B08B 3/02

(57) ABSTRACT

A razor cartridge cleaning device has a housing defining a cleaning chamber therein. A spout seating grommet interfacing a nozzle of decreasing interior cross section directed into the chamber. A clamp frame having a throat adjacent the grommet rotatably retains an adjusting screw having a handle for adjusting a movable jaw thereof within the throat towards the grommet to tightly seal the device to a tap spout.

### FIELD OF THE INVENTION

This invention relates generally to a device for cleaning reusable razor cartridges.

### BACKGROUND OF THE INVENTION

Safety razors comprise a handle and a replaceable razor cartridge housing two or more blades. However, debris buildup may hamper the cutting efficiency of the cartridge and, as such, various devices have been proposed for cleaning razor blades with water.

For example, U.S. Pat. No. 4,027,387 A (KELLIS) 7 Jun. 1977 [hereinafter referred to as D1] discloses a device having a housing having a grommet which is pressed into a spout and a slot for a handle to position a cartridge thereof under the grommet for cleaning.

CN 205757911 U (UNIVERSITY XIHUA) 7 Dec. 2016 [hereinafter referred to as D2] discloses a simple boxlike structure having a grinding block therein retained by an elastic rod and water inlets which agitate the elastic rods and grinding block to sharpen the blades thereof.

U.S. Pat. No. 4,838,949 A (DUGROT) 13 Jun. 1989 [hereinafter referred to as D3] discloses a device having a housing having an entrance which connects to a spout and which has a strap thereabove to hold the spout the entrance. The housing comprises a slot within which a razor may be inserted to position a cartridge thereof beneath the spout for cleaning.

EP 0895733 A1 (KAUP, FRANZ-JOSEF) 10 Feb. 1999 [hereinafter referred to as D4] discloses a device configured to direct a jet of water simultaneously across and rearwardly into a cartridge for cleaning.

GB 2087231 A (STAAR SOCIETE ANONYME) 26 May 1982 [hereinafter referred to as D5] discloses a cleaning device configured to hold a razor cartridge in a correct position and has formations which directs jets of water around the cartridge.

### SUMMARY OF THE DISCLOSURE

There is provided herein and improved razor cartridge cleaning device which overcomes or at least substantially ameliorates at least some of the deficiencies of the prior art, or to at least provides an alternative.

The present cleaning device comprises a cleaning chamber within which razor cartridges are inserted for cleaning. The device has a high-pressure nozzle of decreasing diameter which receives water from a tap spout and directs a pressurised high velocity jet of water between the blades of the cartridge for removing debris therebetween.

In contradistinction with the prior art however, D1 does not comprise such a high pressure nozzle and therefore the relatively low velocity water flow therethrough is less effective at dislodging debris from between the blades of the cartridge. Furthermore, the water inlets of D2 are not directed between the blades of the cartridge and are rather used for introducing turbulence to agitate the flexible grinding rods.

Whereas D3-D5 however do employ pressurise pressurised nozzles in that D3 has inlet leading to a conduit directed onto an angled rear face to provide a high velocity splashback sheet of water and D4 and D5 have tapering inlets, the pressurisation from the present nozzle causes problems for interfacing with the tap spout.

For example, the present nozzle may decrease in diameter substantially such as by a ratio of more than 50 to 1, thereby providing a relatively very high pressurised jet of water for effective cleaning.

In this regard, D3 proposes holding the inlet of the to the spout with a strap. The inlet of D3 has a cylindrical entrance and an O-ring thereabout. However, the fluid tightness between the entrance of D3 and the spout coupled thereto depends entirely on the conformity of the outer diameter of the spout with the inner diameter of the O-ring. As such, D3 cannot be used for spouts of differing diameter. Furthermore, the strap, which may be attached by hook and loop fasteners, may be ill suited to withstand pressurisation and which may allow the device to leak or even blown off the spout unexpectedly. D5 does not propose a high-pressure coupling, other than by the use of a flexible connector which is slightly conical so can be easily fastened to the spout and D4 proposes the use of a quick coupling (such as a conventional garden hose quick coupling connector) for interfacing the spout and the device but which is inconvenient to not only install but to use.

Conversely, the present device comprises a spout seating grommet which interfaces the nozzle. The grommet may be rubberised and have an entrance of decreasing diameter, such as one being frustoconical.

The device further comprises a clamp frame having a throat adjacent the grommet and which is open at least from the rear. The device further comprises an adjusting screw rotatably retained by the clamp frame and having a handle for adjusting a movable jaw thereof within the throat towards the grommet.

As such, the present device may be quickly attached to the spout in a fluid tight manner by inserting the spout via the rear of the throat until the spout substantially collocates with the grommet. The handle is then tightened to press the spout tightly against the grommet in a fluid tight manner.

The grommet allows for a fluid tight connection of spouts of differing diameters and configurations. Furthermore, the clamp frame resiliently holds the device to the spout despite significant pressurisation, avoiding leakage or blowoff as may be problematic with the device of D3.

The tap may then be turned on to cause water to flow via the spout, grommet and via the high pressure nozzle to clean between the blades of the cartridge with a relatively high velocity pressurised jet of water.

In a preferred embodiment, the cleaning chamber of the present device comprises a mechanical shutter which selectively encloses the cleaning chamber to prevents or reduce splashback, especially from a high velocity jet of water.

The cleaning chamber may comprise an entrance across which the shutter is movably engaged. In a preferred embodiment, the entrance is located in front and below the throat of the clamp frame such that the cartridge can be inserted from the front of the device conveniently beneath tap on such that water flows directly down therethrough and falls therefrom into the basin there underneath.

The shutter may be urged upwardly by compression springs to a closed configuration. The shutter may comprise a central recess which may cooperate with a corresponding central recess of the housing to accommodate the handle of the razor therebetween and close behind the cartridge, thereby substantially preventing splashback via the entrance.

The outer edge of the shutter and the corresponding outer edge of the housing may be inwardly curved so that the shutter can be opened by simply pressing the cartridge against the shutter. Furthermore, the inner edges of the shutter and housing may be similarly curved. As such, and with the present device being held in place by the clamping frame, the present device need not be supported by hand and the cartridge may be easily inserted and removed with one hand.

According to one aspect, there is provided a razor cartridge cleaning device having housing defining a cleaning chamber therein, a spout seating grommet interfacing a nozzle of decreasing interior cross section directed into the chamber and a clamp frame having a throat adjacent the grommet an adjusting screw rotatably retained by the clamp frame having a handle for adjusting a movable jaw thereof within the throat towards the grommet.

The nozzle may decreases in cross-section by a ratio of greater than 50:1.

The clamp frame may be open at a front and rear of the device and enclosed at the sides.

The entrance may be located at the front

The grommet may have an entrance of decreasing diameter.

The entrance may be substantially frustoconical.

The grommet may be elastic.

The grommet may be rubberised.

The nozzle may have an annular entrance within which a corresponding cylindrical exterior of the grommet interfaces in a fluid tight manner.

The housing may be bifurcated and wherein the nozzle may comprise a peripheral recess within which closing edges of the portions of the housing locate.

An outlet of the nozzle may be longitudinal.

The outlet may be orientated widthwise with respect to the housing.

The cleaning chamber may have an entrance having a shutter at the entrance deflectable between closed and opened positions.

The device may further comprise a biasing mechanism to bias the shutter towards the closed position.

The biasing mechanism may comprise at least one compression spring engaged between the housing and an undersurface of the shutter.

The shutter may comprise an outer curved edge.

The housing defines an outer curved edge facing the shutter.

The shutter may comprise a shutter central recess.

The housing defines a housing central recess.

The shutter may comprise an inner curved edge.

The housing defines an inner curved edge facing the shutter.

The housing may have a cleaning chamber outlet.

An interior of the housing may slope towards the outlet.

According to another aspect, there is provided a method of cleaning a razor cartridge using the razor cartridge cleaning device, the method comprising inserting a spout of a tap via a rear of the throat until such time that the spout locates substantially above the grommet, turning the handle to clamp the spout between the grommet and the movable jaw, pressing a cartridge against the shutter to deflect the shutter downwardly, thereby passing the cartridge into the cleaning chamber and turning on the tap to direct a high-pressure jet of water towards the cartridge for cleaning.

Other aspects of the invention are also disclosed.

### BRIEF DESCRIPTION OF THE DRAWINGS

Notwithstanding any other forms which may fall within the scope of the present invention, preferred embodiments of the disclosure will now be described, by way of example only, with reference to the accompanying drawings in which:

FIG. 1 shows an underside perspective exploded view of a razor cartridge cleaning device in accordance with an embodiment;

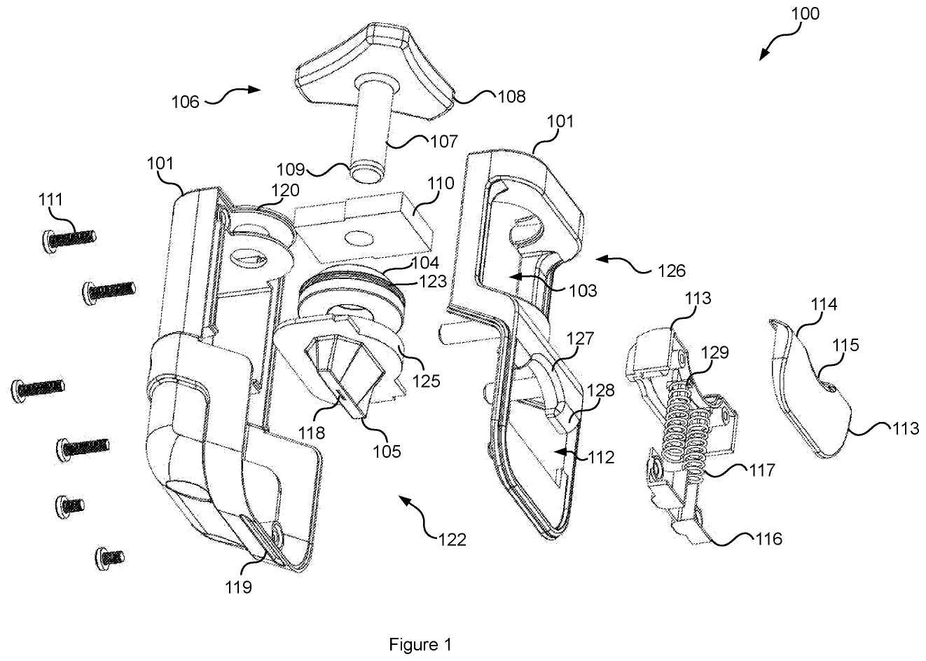

FIG. 2 shows an upper side perspective exploded view of the device;

FIG. 3 shows the device assembled without a front portion of the housing; and

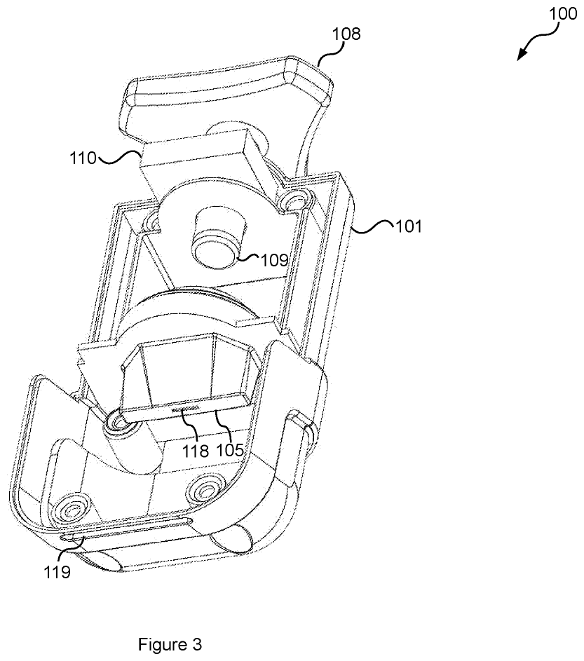

FIGS. 4 and 5 show a shutter of the device in closed and open positions respectively.

### DESCRIPTION OF EMBODIMENTS

A razor blade cartridge cleaning device 100 comprises housing 101 defining a cleaning chamber 122. A cartridge is inserted into the cleaning chamber 122 via an entrance 112 for cleaning with a jet of water from a tap. For orientational convenience, the device 100 will be described with reference to the entrance 112 being at the front of the device 100.

The housing 101 may be bifurcated as shown and held together with screws 112.

The device 100 comprises a nozzle 105 which directs a pressurised jet of water into the cleaning chamber 112.

The nozzle 105 may be of diminishing interior cross section so as to pressurise water passing therethrough which escapes from an outlet 118 thereof at high velocity. The nozzle 105 may diminish and diameter by a ratio of greater than 50:1. The outlet 118 may be longitudinal and orientated widthwise to spray across the cartridge correspondingly located widthwise thereunderneath.

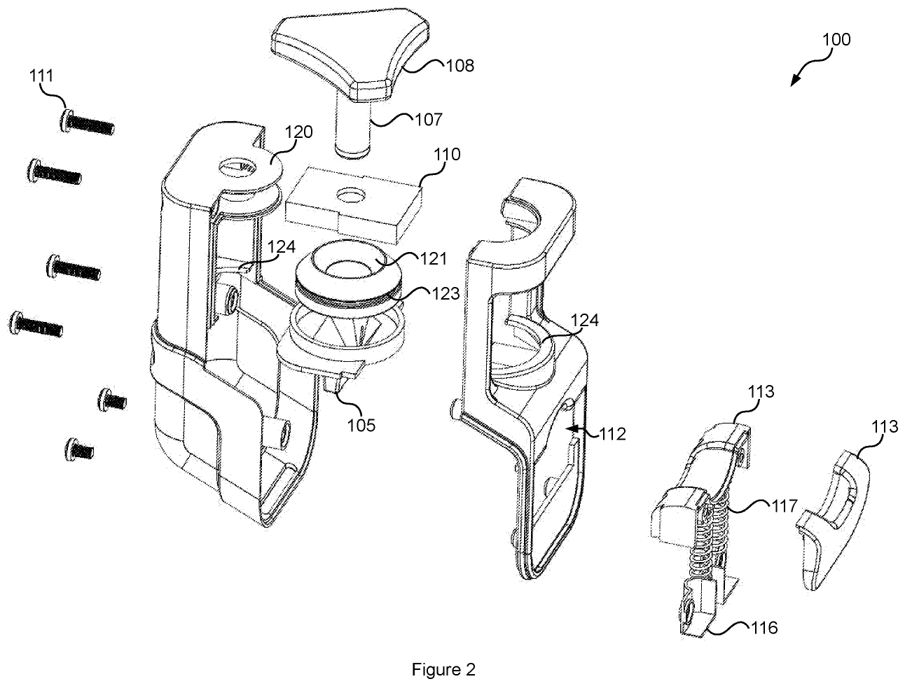

The device 100 may comprise a rubberised spout seating grommet 104 which seals within an annular entrance 125 of the nozzle 105. With reference to FIG. 2, the exterior periphery of the grommet 104 may comprise a peripheral recess 123 which sits within opposing edges 124 of the housing 101.

The grommet 104 may comprise an entrance 121 of decreasing cross-section so as to seal against taps spouts of differing diameters in a fluid tight manner. The entrance 112 may be substantially frustoconical as shown.

The housing defines a clamp frame 125 having a throat 103 adjacent the grommet 104. The frame 125 may be open at the front and rear and enclosed at the sides.

The device 100 may further comprise an adjusting screw 106 rotatably retained by the clamp frame 125. The adjusting screw 106 may comprise a handle 108 and a threaded stem 107 for adjusting a movable jaw 109 thereof within the throat 103 towards the grommet 104. The movable jaw 109 may comprise a rubber interfacing knob having a rearward protrusion retained within a central recess of the stem 107.

The threaded stem 107 may be screwably retained within resilient screw block 110. The screw block may 110 be non-rotatably retained between annular plates 120 of the housing 101.

The entrance 112 may be selectively enclosed by a shutter 113 deflectable between closed and open positions. In the embodiments shown, the shutter 113 may be similarly bifurcated and held together by screws.

The shutter 113 may define a central shutter recess 115 which may cooperate with a corresponding central housing entrance recess 127 of the housing 101 to accommodate the handle of the razor therebetween.

The housing entrance recess 127 may be substantially coincident in elevation with the outlet 118 of the nozzle 105 which may reduce upward splashback from the entrance 112.

Compressed springs 117 retained at lower edges thereof by footing 116 may engage undersurface bosses 129 of the shutter 113 to urge the shutter 113 upwardly.

The shutter 113 may comprise a front inward curved edge 114 such that, when pressed against by the cartridge widthwise therealong, the cartridge urges the shutter 113 downwardly to allow the cartridge to pass.

The housing 101 may similarly comprise a front inner curved edge 128 which urges the cartridge downwardly. As such, when the cartridge is pressed between the housing 101 of the shutter 113, the shutter 113 is urged downwardly.

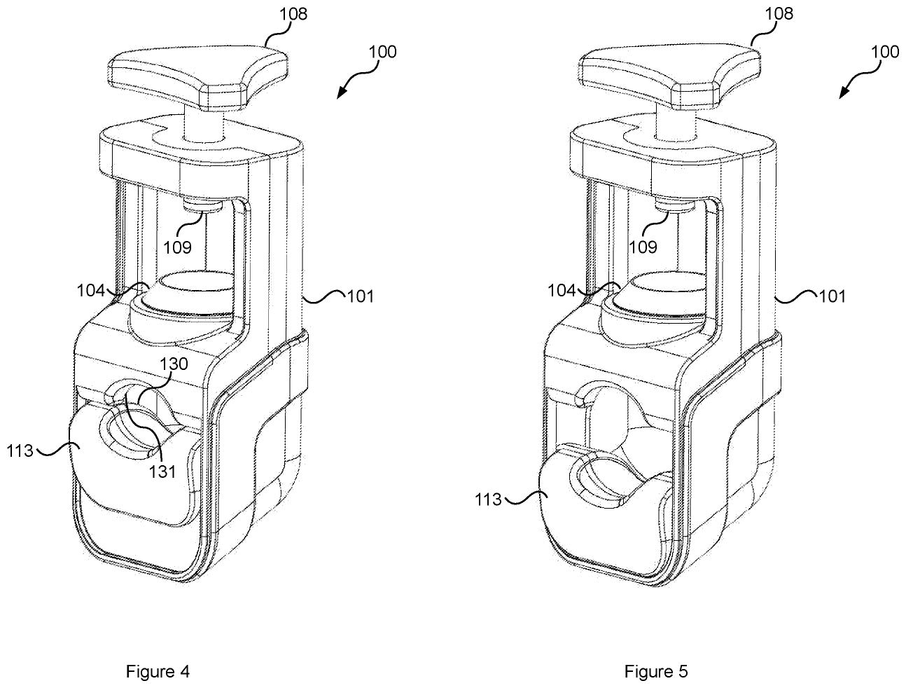

With reference to FIG. 4, the shutter 113 may similarly comprise an inner curved edge 131 which cooperates with adjacent inner curved edge 131 of the housing 101 which deflects the shutter 113 downwardly when the cartridges pulled from the entrance 112. As such, when the handle of the razor is pulled, the cartridge thereof deflects the shutter 131 downwardly. As such, the colleges can be inserted and removed with one hand.

FIG. 4 illustrates the shutter 113 biased by the compression springs 117 to a closed position and the curved edges 114 and 128 defining a widthwise mouth. FIG. 5 illustrates the shutter 113 deflected downwardly within the entrance 112.

The entrance 112 may be in front and beneath the front entrance of the throat 103 such that when a tap spout is clamped to the grommet 104, the entrance 112 is rigidly held and located accessibly in front of the tap.

The housing 101 may comprise an outlet 119 for releasing water from the cleaning chamber 122. The housing 101 may be sloped towards the outlet 119 such that water tends towards the outlet 119.

Utilisation of the device 100 comprises unscrewing the adjusting screw 106 by turning the handle 108 anticlockwise and inserting a spout of a tap via the rear entrance of the throat 103 until such time that the end of the spout locates approximately above the grommet 104. The screw 106 is then tightened by turning the handle 108 clockwise such that the movable jaw 109 thereof presses the spout against the grommet 104. The screw 106 is tightened to sufficiently press the spout against the grommet 104 to form a watertight seal therebetween.

A razor with a cartridge thereof poised horizontally is then pressed between the shutter 113 and the housing 106 at the curved edges 114 and 128 which urges the shutter 114 downwardly to allow the cartridge to pass into the cleaning chamber 122. The shutter 113 returns to the closed position and the recesses 115 and 127 accommodate the handle therebetween. The device may be resiliently held by the clamp frame 126 such that the device 100 may not be supported by hand.

The tap is then turned on which causes water to flow via the grommet 114 into the nozzle 105. The diminishing diameter thereof pressurises the water such that a high velocity jet of water escapes from the outlet 118 of the nozzle 105. The jet of water sprays between the blades of the cartridge, thereby dislodging debris entrapped therebetween. The cartridge may be wiggled from side to side if needs be by manipulating the proximal end of the handle extending from between the shutter 113 and the housing 101. Spent water escapes via the outlet 119.

The cartridge can then be pulled from the cleaning chamber 122 which presses against inner curved edges 130 and 131 of the shutter in housing respectively to deflect the shutter 113 downwardly.

The foregoing description, for purposes of explanation, used specific nomenclature to provide a thorough understanding of the invention. However, it will be apparent to one skilled in the art that specific details are not required in order to practise the invention. Thus, the foregoing descriptions of specific embodiments of the invention are presented for purposes of illustration and description. They are not intended to be exhaustive or to limit the invention to the precise forms disclosed as obviously many modifications and variations are possible in view of the above teachings. The embodiments were chosen and described in order to best explain the principles of the invention and its practical applications, thereby enabling others skilled in the art to best utilize the invention and various embodiments with various modifications as are suited to the particular use contemplated. It is intended that the following claims and their equivalents define the scope of the invention.

1. A razor cartridge cleaning device having housing defining a cleaning chamber therein, a spout seating grommet interfacing a nozzle of decreasing interior cross section directed into the chamber and a clamp frame having a throat adjacent the grommet an adjusting screw rotatably retained by the clamp frame having a handle for adjusting a movable jaw thereof within the throat towards the grommet.

2. A device as claimed in claim 1, wherein the nozzle decreases in cross-section by a ratio of greater than 50:1.

3. A device as claimed in claim 1, wherein the clamp frame is open at a front and rear of the device and enclosed at the sides.

4. A device as claimed in claim 1, wherein the entrance is located at the front

5. A device as claimed in claim 1, wherein the grommet has an entrance of decreasing diameter.

6. A device as claimed in claim 5, wherein the entrance is substantially frustoconical.

7. A device as claimed in claim 1, wherein the grommet is elastic.

8. A device as claimed in claim 1, wherein the grommet is rubberised.

9. A device as claimed in claim 1, wherein the nozzle has an annular entrance within which a corresponding cylindrical exterior of the grommet interfaces in a fluid tight manner.

10. A device as claimed in claim 1, wherein the housing is bifurcated and wherein the nozzle comprises a peripheral recess within which closing edges of the portions of the housing locate.

11. A device as claimed in claim 1, wherein an outlet of the nozzle is longitudinal.

12. A device as claimed in claim 11, wherein the outlet is orientated widthwise with respect to the housing.

13. A device as claimed in claim 1, wherein the cleaning chamber has an entrance having a shutter at the entrance deflectable between closed and opened positions.

14. A device as claimed in claim 13, further comprising a biasing mechanism to bias the shutter towards the closed position.

15. A device as claimed in claim 14, wherein the biasing mechanism comprises at least one compression spring engaged between the housing and an undersurface of the shutter.

16. A device as claimed in claim 14, wherein the shutter comprises an outer curved edge.

17. A device as claimed in claim 16, wherein the housing defines an outer curved edge facing the shutter.

18. A device as claimed in claim 14, wherein the shutter comprises a shutter central recess.

19. A device as claimed in claim 16, wherein the housing defines a housing central recess.

20. A device as claimed in claim 14, wherein the shutter comprises an inner curved edge.

21. A device as claimed in claim 16, wherein the housing defines an inner curved edge facing the shutter.

22. A device as claimed in claim 1, wherein the housing has a cleaning chamber outlet.

23. A device as claimed in claim 22, wherein an interior of the housing slopes towards the outlet.

24. A method of cleaning a razor cartridge using a razor cartridge cleaning device as claimed in claim 13, the method comprising inserting a spout of a tap via a rear of the throat until such time that the spout locates substantially above the grommet, turning the handle to clamp the spout between the grommet and the movable jaw, pressing a cartridge against the shutter to deflect the shutter downwardly, thereby passing the cartridge into the cleaning chamber and turning on the tap to direct a high-pressure jet of water towards the cartridge for cleaning.
